(19) United States
(12) Patent Application Publication
(10) Pub. No.: US 2024/0001464 A1
(43) Pub. Date: Jan. 4, 2024

(54) CUTTING OF SOFT METALS WITH THE AID OF ULTRASOUND

(71) Applicant: HYDRO-QUÉBEC, Montréal (CA)

(72) Inventors: Kamyab AMOUZEGAR, Mont-Royal (CA); Patrick BOUCHARD, Shawinigan (CA); Nancy TURCOTTE, St-Tite (CA); Frédéric PERRON, St-Tite (CA); Dominic LEBLANC, Gentilly (CA); Karim ZAGHIB, Longueuil (CA)

(73) Assignee: HYDRO-QUÉBEC, Montréal (CA)

(21) Appl. No.: 18/469,399

(22) Filed: Sep. 18, 2023

Related U.S. Application Data
(62) Division of application No. 17/312,971, filed on Jun. 11, 2021.

(30) Foreign Application Priority Data
Dec. 13, 2018 (CA) 3027620

(51) Int. Cl. B23D 33/00; B23D 15/04; B23D 36/00; B23D 79/00; H01M 50/406

(52) U.S. Cl. CPC B23D 33/00; B23D 15/04; B23D 36/0008; B23D 79/00; H01M 50/406

(57) ABSTRACT

Method for cutting soft metals, comprising the use of a cutting tool capable of being set in motion by ultrasonic vibration. The method is employed for cutting components used in the manufacture of an electrochemical storage device, for example, a lithium battery. These components include the anodes, the cathodes, the solid electrolytes, the current collectors and the separators. The method is also employed in a system for manufacturing and/or characterizing an electrochemical storage device.

### CROSS REFERENCE TO RELATED APPLICATIONS

This application is a divisional of U.S. application Ser. No. 17/312,971, filed Ju. 11, 2021, titled “CUTTING OF SOFT METALS WITH THE AID OF ULTRASOUND,” which is a U.S. National Phase Under 35 U.S.C. § 371 of International Application No. PCT/CA2019/051782, titled “CUTTING SOFT METALS WITH THE AID OF ULTRASOUND,” filed Dec. 11, 2019, which is a PCT application claiming priority to Canadian Application No. 3,027,620 filed on Dec. 13, 2018, the disclosures of all of which are incorporated herein by reference in their entireties.

### FIELD OF THE INVENTION

This invention relates to a method for cutting soft metals in general. In particular, the invention relates to a method using a system comprising a cutting blade set in motion by ultrasonic vibration for cutting soft metals. The method according to the invention is employed for cutting components used in the manufacture of electrochemical storage devices, for example, lithium batteries. These components include the anodes, the cathodes, the solid electrolytes, the current collectors, and the separators.

### BACKGROUND OF THE INVENTION

Ultrasound is a mechanical and elastic wave, which propagates through fluid, solid, gaseous or liquid media. The frequency range of ultrasound is between 16,000 and 10,000,000 Hertz. Such frequencies are too high to be perceived by the human ear.

Ultrasound has several industrial applications. For example, it is used in the non-destructive testing of parts. Ultrasound is also used in fields directly affecting living beings, such as medical ultrasounds, surgery (unblocking of arteries, hip replacement, liposuction, etc.). Other fields of use of ultrasound include mixing of fluids that are otherwise difficult to mix, cleaning of parts, dust removal of fumes, welding of plastics and metals, machining [1].

The term “ultrasound” can also be used to describe technical assistance processes. For example, assistance in precision grinding, in cutting (in turning, drilling, milling), in electroerosion, in injection, in extrusion pressing, etc. In these cases of assistance processes, the physical principle of the method remains the same. Ultrasonic vibrations improve the performance, either through a reduction of the frictional conditions or through the creation of the intense conditions required [1].

Different mechanisms can be used to convert electrical energy into mechanical energy, for the development of ultrasonic wave generators. These mechanisms include, for example, electrodynamic, electrostatic, magnetic, magnetostrictive, electrostrictive, piezoelectric effects [1].

When assisting in cutting, ultrasound provides a significant reduction in cutting forces, an improvement in the surface finish and a reduction in wear of the tool used [1]. In addition, there is less adhesion of material to the tool used.

Cutting is a mechanical operation for dimensional reduction that is done with a tool, often called a cutting tool, and that allows solid materials to be divided according to a precise geometry, in order to obtain pieces of reduced size, or to separate different parts [2].

Ultrasound has been used for a long time within very advanced technologies such as welding and medical imaging. Ultrasound technology has been applied to the cutting of food products, for example, the cutting of pastries [3]. This technology has developed strongly in this sector and now provides many solutions to the problems associated with cutting soft, sticky, chewy, crumbly, and/or heterogeneous foodstuffs [2].

Ultrasound is not used as a cutting tool as such. Ultrasound is used to improve the performance of a cutting tool, for example, a blade driven by a guillotine motion. Ultrasound is therefore applied to the blade. Said blade can have a particular geometry.

Typically, to produce ultrasound, a 60 Hz electric current is transformed into a 20 kHz current by means of a generator. This generator will excite a piezoelectric composed of four layers of ceramic. This ceramic, which retracts under the electrical effect 20,000 times per second, transforms the electrical energy into mechanical energy, which is amplified by a booster and transmitted to the blade. By vibrating at high frequency (20 kHz), this blade makes micro-displacements of an amplitude of 50 to 100 μm. The blade wire is then subjected to a large mechanical acceleration in the order of 10⁵ g, which causes the breakage of the material under the blade. The amplification depends on the product to be processed: the softer it is, the less amplification there will be. In parallel to this vibration of the blade, the cutting tool is lowered. The cutting is therefore done without compression of the product and without friction, which makes it possible to obtain beautiful cutting surfaces even with very sticky or very fragile products [2].

The technique of cutting assisted by ultrasound allows for the easy cutting of materials that are difficult to cut. Such materials include carbon materials, rubber, thermoplastics, leather, fabrics, nonwovens, paper, plastic sheets, etc. However, for the cutting of ductile materials, such as soft metals, it has always been considered to be more cost-effective making use of other techniques, such as standard cutting, electroerosion, electrochemistry [1].

The cutting of soft alkali metals such as lithium, sodium, potassium, etc. poses specific problems. For example, deformation of the parts to be cut, heating of the cutting tools, buttering of the tools. Moreover, a poor surface finish is often noted. The use of common tools such as saws, knives (slice, guillotine, rotary blade, scissors etc.), cutting wires, hot wires, cutting lasers and other erosion techniques generally leads to unsatisfactory results. Furthermore, when manufacturing assemblies including these metals, such as lithium battery devices, conventional cutting techniques become inoperable.

The inventors are aware of U.S. Pat. No. 5,250,784 which describes a laser-assisted cutting technique for cutting an assembly of multiple films including an electrochemical film [5]

There is a need for efficient soft metal cutting methods. In particular, there is a need for efficient methods for cutting components used in the manufacture of electrochemical storage devices, such as lithium batteries.

There is likewise a need for methods of cutting an electrochemical storage device, such as a cell, so as to allow characterization of the cell.

### SUMMARY OF THE INVENTION

The inventors have designed and employed a method for cutting soft metals. The method according to the invention uses a system comprising a cutting blade set in motion by ultrasonic vibration. The method is employed for cutting components used in the manufacture of electrochemical storage devices, for example lithium batteries. Such components include the anodes, the cathodes, the solid electrolytes, the current collectors and the separators. These components can be cut individually or when assembled, for example as a multilayer assembly. The method is also employed in a system for manufacturing and/or characterizing an electrochemical storage device.

The method according to the invention allows for the elimination of friction and consequently the reduction of cutting forces, the reduction of the short-circuit time of an assembled cell during cutting, the minimization of the tool buttering, the reduction of the heating and the wear of the tool used. Also, the method according to the invention provides an improved cut finish.

According to one embodiment of the invention, the method uses a cutting tool set in motion by ultrasonic vibration. According to another embodiment of the invention, the cutting tool comprises at least one blade coupled to an ultrasonic generator.

According to one embodiment of the invention, the components of the electrochemical storage device may be cut individually, or during the manufacture of the device. The components of the electrochemical storage device may also be cut when they are assembled, for example, when it is desired to perform an examination of the device to determine its architecture (characterization of the electrochemical storage device). During such a method of characterization, the cutting tool may be coupled to a microscope and/or a device that can be used to measure, for example, the thickness of each layer of the various components of the electrochemical storage device.

Therefore, the invention relates to the following aspects:
(1) A method for cutting soft metals, comprising the use of a cutting tool adapted to be set in motion by ultrasonic vibration.
(2) A system for cutting soft metals, comprising a cutting tool adapted to be set in motion by ultrasonic vibration.
(3) A method for manufacturing and/or characterizing an electrochemical storage device, comprising the use of a cutting tool adapted to be set in motion by ultrasonic vibration.
(4) A system for manufacturing and/or characterizing an electrochemical storage device, comprising a cutting tool adapted to be set in motion by ultrasonic vibration.
(5) The method or system according to aspect (3) or (4) above, wherein the electrochemical storage device is a lithium battery, an “entirely solid” lithium battery, a lithium ion battery, or a cell.
(6) The method or system according to any one of the aspects (1) to (5) above, wherein the cutting tool comprises at least one cutting blade coupled to an ultrasonic generator.
(7) The method or system according to aspect (6) above, wherein the cutting blade is: a blade adapted to be set in motion by a guillotine motion, a razor blade, a diamond blade, an exacto blade, a steel blade, a blade made of tungsten carbide, or a combination of these.
(8) The method or system according to any one of the aspects (1) to (7) above, wherein the cutting tool is a microtome.
(9) The method or system according to any one of the aspects (1) to (8) above, wherein the soft metals are metals having high malleability at room temperature, preferably Pb, Na, Ca, Sr, K, Mg, Al, Sn, Au, Pt, Ba, Cu, Ag, Cd, In, Ga, Bi, Fe, Zn, Li, Ni, Pd, Cs, Rb, and alloys thereof; or metals having a hardness of less than 4 on the Mohs scale.
(10) The method or system according to any one of the aspects (1) to (8) above, wherein the soft metals are soft alkali metals; preferably Li, Na, K, Mg, Ca or alloys thereof.
(11) The method or system according to any one of the aspects (1) to (8) above, wherein the soft metals are metals that are malleable at a temperature greater than room temperature; preferably the method comprises the use of a thermal protection system, or the system further comprises a thermal protection system.
(12) A method for manufacturing and/or characterizing an electrochemical storage device, comprising at least one step of cutting at least one component of the electrochemical storage device, the cutting being performed using a cutting tool adapted to be set in motion by ultrasonic vibration.
(13) A system for manufacturing and/or characterizing an electrochemical storage device, comprising at least one cutting tool for cutting at least one component of the electrochemical device, the cutting tool being adapted to be set in motion by ultrasonic vibration.
(14) The method or system according to aspect (12) or aspect (13) above, wherein the electrochemical storage device is a lithium battery, an “entirely solid” lithium battery, a lithium ion battery, or a cell.
(15) The method or system according to any one of the aspects (12) to (14) above, wherein the component of the electrochemical storage device is a negative electrode, a positive electrode, a solid electrolyte, a current collector, a separator, or a combination of these components.
(16) The method or system according to aspect (15) above, wherein: the negative electrode consists of a metal foil having a base of alkali metals, preferably lithium, lithium-aluminum alloys or the like; the positive electrode consists of a composite mixture, preferably a material containing a redox active center (transition metal oxide), an electrically conductive filler material (carbon particles), a solid electrolyte material (ionic conductor); the solid electrolyte consists of polymer, glass, ceramic or a mixture thereof; the current collector consists of a metal foil, preferably a foil of Al, Ni, Cu, or a combination of these; optionally, the current collector is an anode material, e.g. lithium; and the separator consists of polymer or ceramic material.
(17) The method or system according to any one of the aspects (12) to (16) above, wherein the cutting tool comprises at least one cutting blade coupled to an ultrasonic generator.
(18) The method or system according to aspect (17) above, wherein the cutting blade is: a blade adapted to be driven by a guillotine motion, a razor blade, a diamond blade, an exacto blade, a steel blade, a blade made of tungsten carbide, or a combination of these.
(19) The method or system according to any one of the aspects (12) to (18), wherein the cutting tool is a microtome.
(20) The method or system according to any one of the aspects (12) to (19) above, wherein the manufacturing comprises at least one of the following steps: a stacking or assembling of the components of the electrochemical storage device; a resizing of the components of the electrochemical storage device; an extrusion of a billet originating from the melting of an ingot of material constituting a component of the electrochemical storage device, preferably a lithium billet; a resizing of a cell or battery half-cell; and a stacking of two-sided cells.
(21) The method or system according to any one of the aspects (1) to (20), wherein the cutting tool comprises: a blade having a high hardness; and/or a blade the surface of which has been modified by heat treatment, preferably by carburizing, nitriding, quenching, ceramic deposition, or a combination of these; and/or a blade made of a wear resistant material, preferably tungsten carbide, silicon carbide, diamond, alumina, zirconium, silicon nitride, or a combination of these; and/or a blade made of an electrically insulating material.
(22) A system for the characterization of an electrochemical storage device (lithium battery or “entirely solid” lithium battery or a lithium-ion battery or cell), comprising: a cutting tool adapted to be set in motion by ultrasonic vibration, preferably the tool is a microtome; and/or a microscope; and/or a measuring device.
(23) The system according to aspect (22) above, wherein the cutting tool comprises at least one cutting blade coupled to an ultrasonic generator.
(24) An electrochemical storage device obtained by a method that comprises the method as defined in any one of the aspects (1) to (21) above, or that uses the system as defined in any one of the aspects (1) to (23).
(25) A lithium battery or “entirely solid” lithium battery or a lithium ion battery or cell, obtained by a method that comprises the method as defined in any one of the aspects (1) to (21), or that uses the system as defined in any one of the aspects (1) to (23).

Further objects, advantages and functions of this invention will become more apparent in the following description of possible embodiments, given by way of example only, in connection with the following figures.

### BRIEF DESCRIPTION OF THE FIGURES

The patent or application file contains at least one color figure. Copies of the published patent or application with the color figures will be provided by the Office upon request and payment of the required fee.

FIG. 1: Structure of an “entirely solid” lithium battery according to the prior art [4].

FIG. 2: Cut of lithium metal according to a standard method, without ultrasonic assistance.

FIG. 3: Lithium metal cut with ultrasonic assistance.

FIG. 4: Device for cutting a round lithium rod.

FIG. 5: Result of the cut of the round lithium rod according to FIG. 4, A) without ultrasound assistance, B) with ultrasound assistance.

FIG. 6: Longitudinal cut of a lithium ingot with ultrasonic assistance.

### DESCRIPTION OF EMBODIMENTS OF THE INVENTION

Before this invention is further described, it should be understood that the invention is not limited to the particular embodiments described below, as variations of these embodiments may be realized and remain within the scope of the appended claims. It should also be understood that the terminology used is intended to describe particular embodiments and is not intended to be limiting. Instead, the scope of this invention will be established by the appended claims.

In order to provide a clear and coherent understanding of the terms used in this description, a number of definitions are provided below. In addition, unless otherwise indicated, all technical and scientific terms, as used in this document, have the same meaning as commonly understood in the technical field to which the invention relates.

As used in this document, the term “ultrasound” refers to a mechanical and elastic wave, which propagates through fluid, solid, gaseous or liquid media. The frequency range of ultrasound is generally between 16,000 and 10,000,000 Hertz.

As used in this document, the term “soft metals” refers to metals with high malleability/plasticity at room temperature. Examples of such metals are Pb, Na, Ca, Sr, K, Mg, Al, Sn, Au, Pt, Ba, Cu, Ag, Cd, In, Ga, Bi, Fe, Zn, Li, Ni, Pd, Cs, Rb and their alloys.

As used in this document, the term “soft alkali metals” refers to alkali metals exhibiting high malleability/plasticity at room temperature. Examples of such metals are Li, Na, K, Mg, Ca, and their alloys.

As used in this document, the term “‘entirely solid’ lithium battery” refers to a lithium battery in which the electrolyte is in solid form.

As used in this document, the term “electrochemical storage device” means a rechargeable battery, a battery, a cell, a lithium battery, an “entirely solid” lithium battery, a lithium ion battery, or any other type of storage device.

As used in this document, the term “cutting”refers to a mechanical operation that allows to divide and/or separate a piece of solid material according to a determined geometry. The division and/or separation allows pieces of reduced size and/or different geometrical shapes.

As used in this document, the term “characterization” refers to a method by which the electrochemical storage device is examined to determine its architecture. An example of this method is measuring the thickness of each layer of the various components of the cell. This examination method may be linked to a microscope and/or measuring device. This examination method incorporates the cutting method according to the invention, with a microtome (ultrasonically assisted microtomy) as the cutting tool.

The inventors have designed and employed a method for cutting soft metals. The method according to the invention uses a system comprising a cutting blade set in motion by ultrasonic vibration. The method is employed for cutting components used in the manufacture of electrochemical storage devices, for example, lithium batteries. Such components include the anodes, the cathodes, the solid electrolytes, the current collectors and the separators. These components can be cut up individually or when assembled, for example, as a multilayer assembly. The method is also employed in a system for manufacturing and/or characterizing an electrochemical storage device.

The method according to the invention allows for the elimination of friction and consequently, the reduction of cutting forces, the reduction of the short-circuit time of an assembled cell during cutting, the minimization of the tool buttering, the reduction of the heating and the wear of the tool used. Also, the method according to the invention provides an improved cut finish.

According to one embodiment of the invention, the method uses a cutting tool set in motion by ultrasonic vibration. According to another embodiment of the invention, the cutting tool comprises at least one blade coupled to an ultrasonic generator.

According to one embodiment of the invention, the components of the electrochemical storage device may be cut individually, or during the manufacture of the device. The components of the electrochemical storage device may also be cut when assembled, for example, when it is desired to perform an examination of the device to determine its architecture (characterization of the electrochemical storage device). During such a characterization method, the cutting tool may be coupled to a microscope and/or a device that can be used to measure, for example, the thickness of each layer of the various components of the electrochemical storage device.

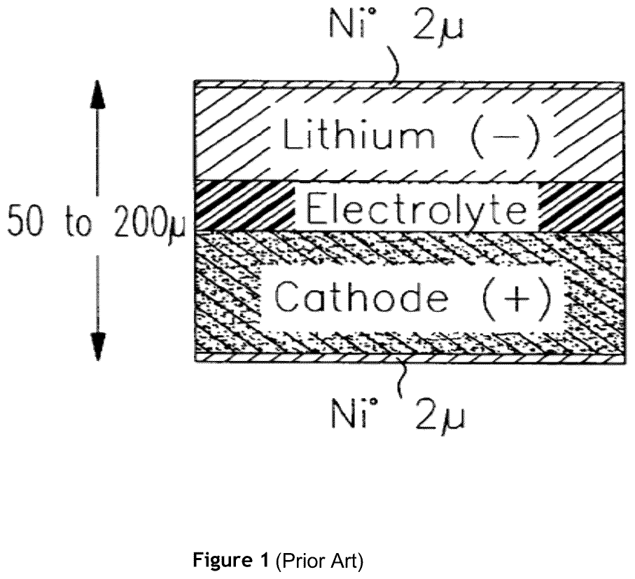

The invention includes the application of ultrasonic assistance to the cutting of soft metals. The invention addresses the cutting problems of components used in the manufacture of electrochemical storage devices, such as an “entirely solid” lithium battery, a lithium-ion battery, or a cell. FIG. 1 reproduced from U.S. Pat. No. 6,030,421 [4] illustrates the structure of such a battery. According to one aspect, the invention allows the cutting of an ingot that is used in extruding a lithium strip.

Different mechanisms can be used to produce ultrasound; most modern power converters use the piezoelectric effect. The amplitude and frequency of the vibrations and the static load have an influence on the results of the cut. Most installations work at frequencies around 20 kHz, which are close to the lowest frequency compatible with the human ear.

Optionally, a lubricant, such as a mineral cutting oil, is used. The lubricant helps to reduce heating of the workpiece and the cutting tool. The lubricant also helps eliminate surface oxidation of the tool and of the material being cut and improves the finish of the cut.

To reduce knife wear, it may be advantageous to use a cutting tool with a knife that has a high degree of hardness and/or a surface that has been modified by various treatments (carburizing, nitriding, quenching, ceramic deposition, or a combination of these). It may also be advantageous to use a cutting tool having a knife made of a wear-resistant material (tungsten carbide, silicon carbide, diamond, alumina, zirconium, silicon nitride, or a combination of these) and/or made of an electrically insulating material.

The soft metals contemplated according to the invention are those metals presenting a high degree of malleability (high plasticity) at room temperature. Such metals include Pb, Na, Ca, Sr, K, Mg, Al, Sn, Ari, Pt, Ba, Cu, Ag, Cd, In, Ga, Bi, Fe, Zn, Li, Ni, Pd, Cs, Rb, and alloys thereof. Those metals presenting a malleability at higher temperatures can nevertheless be cut by the method according to the invention. In such a case, the method is carried out ensuring a thermal protection by ultrasonic assistance to the cutting system.

An “entirely solid” lithium battery is composed of several components. In the case of an LMP (“lithium metal polymer”) cell, the negative electrode is generally made of an alkali metal light-metal-foil: lithium metal, a lithium-aluminium alloy or the like. In the case of a lithium-ion cell, the negative electrode is usually made up of graphite as active material, deposited on a current collector layer (usually Cu or Ni). The positive electrode is usually made of a composite mixture-material containing a redox active center (transition metal oxide), an electrically conductive filler material (usually carbon particles), a solid electrolyte material (ionic conductor); the composite material deposited on a current collector (usually a thin aluminium foil). The solid electrolyte is usually made of polymer, glass, ceramic or a mixture of these; and allows the conduction of lithium ions (Li⁺). The “entirely solid” lithium battery is manufactured by the layering of the positive electrode, the solid electrolyte and the negative electrode. The method is illustrated in FIG. 1 of U.S. Pat. No. 6,030,421 [4].

The method is employed in a system for manufacturing an electrochemical storage device. The method according to the invention is also employed in a system for characterizing an electrochemical storage device. According to one mode of the invention, the system is adapted for use in the fabrication and characterization of an electrochemical storage device. The storage device may be a lithium battery, an “entirely solid” lithium battery, a lithium ion battery, or a cell.

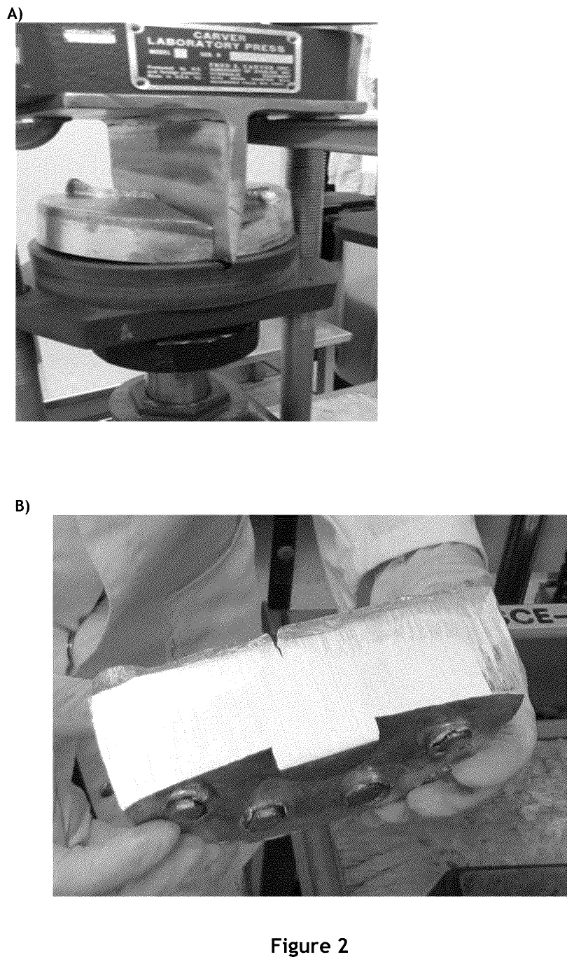

Example 1: A piece of lithium is cut with a guillotine blade using a standard method, without ultrasonic assistance (FIG. 2A). Cutting tests show significant deformation of the piece, due to the application of high pressure. A poor surface finish is also observed (FIG. 2B).

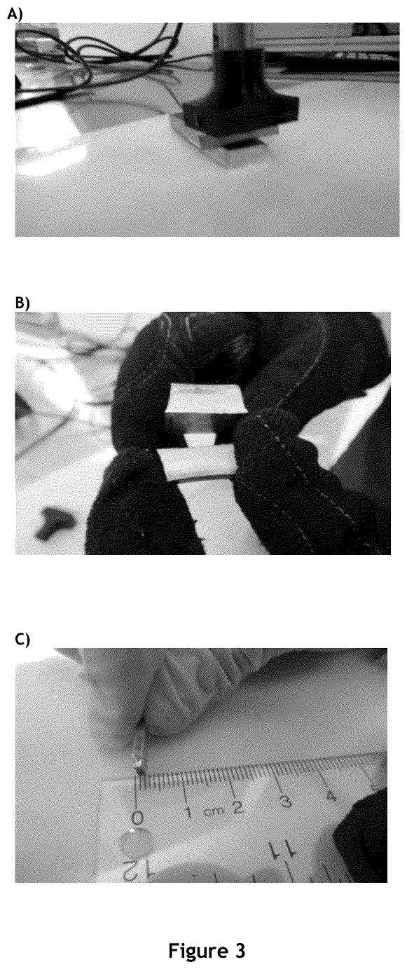

Example 2: A piece of lithium is cut with a razor blade operated with a 20 kHz, 750 W ultrasonic generator (Cole-Palmer) (FIG. 3A). A small amount of light mineral oil is used as a lubricant to protect the lithium from oxidation during the cutting operation. The cut is force-free, fast, and the surface finish is of good quality (FIG. 3B and FIG. 3C). The amplitude is modulated between 20 and 80%; this influences the cutting speed. The lithium does not stick to the blade.

Example 3: An ultrasound-assisted microtome is used to cut a cell to be studied under a microscope. A vibrating diamond blade cuts a complete cell to visualize the cross section. The cut exposes the different components of the cell (the current collectors, the anode, the cathode, the solid electrolyte, the metal-plastic bag). The cut is clean, only a slight deformation of the different thicknesses of the cell components is observed.

Example 4: During the method of manufacturing an “entirely solid” battery by stacking two-sided cells, the live (chemically active) cell is cut with a blade by ultrasonic assistance. A short circuit is created (sharp cut) by the action of the metal knife, but the speed of the cut and its sharpness eliminates the need to use chemical healing of the cell edges.

Example 5: An aluminum strip is slit anew to reduce its width. An ultrasonic assisted exacto blade is used in the method. A clean cut without tearing is obtained. This method is typically used to resize the current collectors, the anodes, the cathodes, the solid electrolytes, the cells, the half-cells, or any other combination of the cell components. It is noted that the durability of the blade is increased.

Example 6: A lithium ingot 6 inches in diameter and 24 inches long is cast by a melting method. The billet, when removed from the mold, has ends that include imperfections (shrinkage area, porosity, inclusions). In order for the ingot to be extruded without generating defects, the ends are cut using a steel blade with an ultrasound assisted system. A clean finish of the cuts is noted.

Example 7: Ultrasonic assisted cutting was tested on several soft metals at room temperature. The metals tested include: Pb, Na, Ca, Mg, Al, Cu, Ni. All metals that had a hardness below 4 on the Mohs scale were successfully cut and a fairly clean finish was noted.

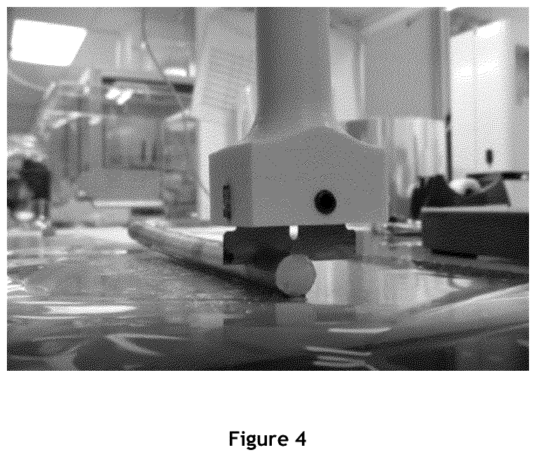

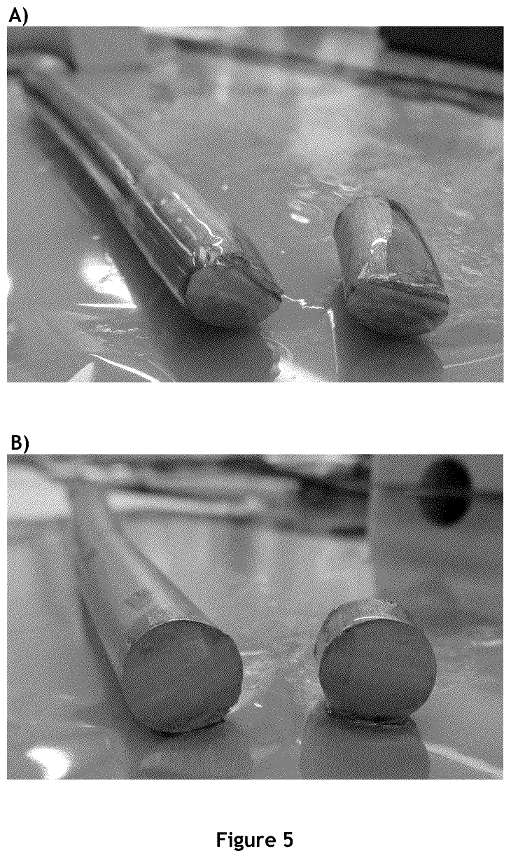

Example 8: Tests were performed to measure the impact of cutting pressure on the deformation of a 10 mm diameter round lithium rod. The setup used is shown in FIG. 4. The rod is coated with mineral oil to reduce heating of the blade. FIG. 5A shows the result obtained after cutting without ultrasound assistance. FIG. 5B shows the result obtained after cutting with ultrasound assistance. The difference is obvious: the cut with ultrasonic assistance produces a clear result. Indeed, the ultrasonic assistance greatly reduces the pressure applied to perform the cut; and the metal remains virtually intact, with no apparent deformation.

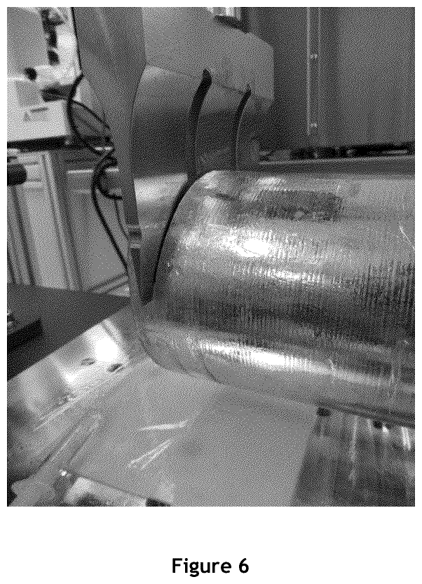

Example 9: A test was performed using an ultrasonic press with integrated generator (TED 2000X, Telsonic) with a sonotrode blade (TE 20 42328, Telsonic). The 150 mm wide by 60 mm high blade, coated with mineral oil and vibrating at an ultrasonic frequency (20 kHz) sliced the lithium ingot along its effective length, cutting it accurately with a clean cut without significantly deforming the ingot. The cut is shown in FIG. 6.

The above examples relate to an “entirely solid” lithium battery. The person skilled in the art understands that the invention also relates to other types of batteries including lithium batteries, lithium ion batteries, cells.

The claims should not be limited in scope by the embodiments illustrated in the examples, but should be given the broadest interpretation consistent with the description as a whole.

The present description refers to a number of documents. The contents of each of these documents are incorporated in their entirety into the present description by reference.

### REFERENCES

1. D. Kremer, “Usinage par Ultrasons”, Techniques de l'Ingénieur (Apr. 10, 1998), Ref.: BM7240 V1.
2. S. Roustel, “Découpe des Produits Aiimen aires”, Techniques de l'Ingénieur (Mar. 10, 2002), Ref.: F1230 V1.
3. U.S. Pat. No. 1,354,505 of M. W. Round “Method of, and Apparatus for Cutting a Blanket of Confectionery Product”.
4. U.S. Pat. No. 6,030,421 of M. Gauthier, G. Lessard, G. Vassort, P. Bouchard, A. Vallee and M. Perrier “Ultra-Thin Solid-State Lithium Batteries and Process of Preparing Same”.
5. U.S. Pat. No. 5,250,784 of D. Muller and B. Kapfer “Method and Device for Cutting a Multilayer Assembly Composed of a Plurality of Thin Films and Comprising a thin Film Electrochemical Generator or a Component Part Thereof”.

1. A method for manufacturing an electrochemical storage device comprising at least one component having a lithium material, the method comprising at least one step of cutting the at least one component using a cutting tool having at least one cutting blade adapted to be set in motion by ultrasonic vibration.

2. A system for manufacturing an electrochemical storage device comprising at least one component having a lithium material, the method comprising at least one cutting tool for cutting the at least one component, the cutting tool having at least one cutting blade adapted to be set in motion by ultrasonic vibration.

3. The method of claim 1, wherein the electrochemical storage device comprising at least one component having a lithium material is a lithium battery, an “entirely solid” lithium battery, a lithium-ion battery, or a cell.

4. The method of claim 1, wherein the at least one component of the having a lithium material is a negative electrode, a positive electrode, a solid electrolyte, a current collector, a separator, or a combination of these.

5. The method of claim 4, wherein:
the negative electrode consists of an alkali metal foil;
the positive electrode consists of a composite mixture;
the current collector consists of a metal foil; and
the separator consists of polymer or ceramic material.

6. The method of claim 1, wherein the cutting tool comprises at least one cutting blade is coupled to an ultrasonic generator.

7. The method of claim 6, wherein the at least one cutting blade is: a blade adapted to be driven by a guillotine motion, a razor blade, a diamond blade, an exacta blade, a steel blade, a blade made of tungsten carbide, or a combination of these.

8. The method of claim 1, wherein the cutting tool is a microtome.

9. The method of claim 1, wherein the manufacturing comprises at least one of the following steps:
a stacking or assembly of the components of the electrochemical storage device;
a resizing of the components of the electrochemical storage device;
an extrusion from a billet originating from the melting of an ingot of material constituting a component of the electrochemical storage device;
a re-dimensioning of a cell or half-cell; and
a stacking of two-sided cells.

10. The method of 1, wherein the cutting tool comprises:
a blade with a high degree of hardness; and/or a blade with a surface that has been modified by heat treatment; and/or
a blade made of a wear resistant material; and/or
a blade made of an electrically insulating material.

11. A system for characterizing an electrochemical storage device comprising at least one component having a lithium material (lithium battery or “entirely solid” lithium battery or a lithium-ion battery or cell), comprising:
a cutting tool having at east one cutting blade adapted to be set in motion by ultrasonic vibration; and/or
a microscope; and/or
a measuring device.

12. The system of claim 11, wherein the cutting tool comprises at least one cutting blade coupled to an ultrasonic generator.

13. An electrochemical storage device comprising at least one component having a lithium material, which is obtained by a method that includes the method as defined in claim 10.

14. A lithium battery or “entirely solid” lithium battery or a lithium-ion battery or cell, obtained by a method which comprises the method as defined in claim 10.
